(19) United States
(12) Patent Application Publication
(10) Pub. No.: US 2025/0258698 A1
(43) Pub. Date: Aug. 14, 2025

(54) SYSTEMS AND METHODS FOR DETERMINING AND PRIORITIZING INTERRUPTION EVENTS TO IMPROVE COMPUTER PROCESSING AND PERFORMANCE IN AN ELECTRONIC NETWORK

(71) Applicant: BANK OF AMERICA CORPORATION, Charlotte, NC (US)

(72) Inventors: Syed Kashif Saeed, New Delhi (IN); Ketan J. Ghelani, Mumbai (IN); Jenetta John, Mumbai (IN); Rajkumarr Singaaravelu, Chennai (IN); Avinash Basavant Nigudkar, Mumbai (IN)

(73) Assignee: BANK OF AMERICA CORPORATION, Charlotte, NC (US)

(21) Appl. No.: 18/437,683

(22) Filed: Feb. 9, 2024

(51) Int. Cl. G06F 9/48

(52) U.S. Cl. CPC G06F 9/4818

(57) ABSTRACT

Systems, computer program products, and methods are described herein for determining and prioritizing interruption events to improve computer processing and performance in an electronic network. The present invention is configured to identify at least one interruption event; apply the at least one interruption event to a stochastic diffusion search (SDS) engine; determine, by the SDS engine, a number of computing agents; analyze the at least one interruption event by the number of computing agents; update, by the number of computing agents, at least one agent priority state for the at least one interruption event; apply the at least one agent priority state to a diagnostic inference model (DIM); and determine, by the DIM, whether the at least one interruption event is a critical event, a non-critical event, or a false event.

### FIELD OF THE INVENTION

The present invention embraces a system for determining and prioritizing interruption events to improve computer processing and performance in an electronic network.

### BACKGROUND

Computing systems and their components, especially servers, applications, and networks, can be randomly inundated by interruption events which can be difficult to manage, prioritize, and expect. Such interruption events can happen in what some in the industry call, “event floods,” where a sudden occurrence of a huge volumes of alerts and interruptions are received or identified within a computing system or its network of components, which can lead to slower processing speeds, unintended outages, and/or the like. The problem is even more exacerbated when each interruption event is only handled based on the priority of when they are identified or received, rather than based on importance or criticality to the overall computing system and network. Thus, there exists a need for a system and/or method that can accurately, efficiently, and dynamically determine each interruption event's criticality, priority, and importance such that each interruption event is handled without the need for human intervention and without unnecessary delay or down-time.

Applicant has identified a number of deficiencies and problems associated with determining and prioritizing interruption events to improve computer processing and performance in an electronic network. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for determining and prioritizing interruption events to improve computer processing and performance in an electronic network. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify at least one interruption event; apply the at least one interruption event to a stochastic diffusion search (SDS) engine; determine, by the SDS engine, a number of computing agents; analyze the at least one interruption event by the number of computing agents; update, by the number of computing agents, at least one agent priority state for the at least one interruption event; apply the at least one agent priority state to a diagnostic inference model (DIM); and determine, by the DIM, whether the at least one interruption event is a critical event, a non-critical event, or a false event.

In some embodiments, the computer-readable code is configured to cause the at least one processing device to: determine a prioritization of the at least one interruption event based on whether the at least one interruption event is the critical event, the non-critical event, or the false event; and apply the at least one interruption event to an event management system based on the prioritization.

In some embodiments, the computer-readable code is configured to cause the at least one processing device to: apply the at least one interruption event to an artificial intelligence (AI) plugin, wherein the AI plugin is trained to predict an idle time or a peak load time associated with a server; and determine, based on the idle time or the peak load time, a mode associated with the number of computing agents, wherein the mode determined dynamically scales the number of computing agents to analyze the at least one interruption event. In some embodiments, the AI plugin is pretrained based on a metrics database comprising historical data of the server, further comprising optimal performance time and optimal response time. In some embodiments, the mode comprises at least one of an idle mode, a self-healing mode, a normal mode, or a high performance mode.

In some embodiments, the computer-readable code is configured to cause the at least one processing device to: apply the at least one interruption event to at least one bot trained with a metrics database, wherein the metrics database comprises historical metric data associated with historical interruption events.

In some embodiments, the at least one agent priority state is associated with at least one of a weight or a confidence score. In some embodiments, the at least one of the weight or the confidence score is compared to at least one belief state threshold, and based on the comparison, the at least one agent priority state is determined.

In some embodiments, the number of computing agents exchange data in a diffusion process, and wherein the diffusion process further comprises a probabilistic exchange between the number of computing agents. In some embodiments, the data in the diffusion process comprises event type data, timestamp data, or associated metadata of the at least one interruption event.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for generating an interactive 3D environment using spatial computing to generate historical digital components, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for determining and prioritizing interruption events to improve computer processing and performance in an electronic network, in accordance with an embodiment of the disclosure;

FIG. 4 illustrates a process flow for applying the at least one interruption event to an event management system based on the prioritization, in accordance with an embodiment of the disclosure;

FIG. 5 illustrates a process flow for determining a mode associated with the number of computing agents, in accordance with an embodiment of the disclosure;

FIG. 6 illustrates a process flow for applying the at least one interruption event to at least one bot trained with a metrics database, in accordance with an embodiment of the disclosure; and

FIG. 7 illustrates an exemplary flow diagram for determining and prioritizing interruption events to improve computer processing and performance in an electronic network, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, and the like, and/or the ability and opportunity to access and use the same. Some example implementations herein contemplate property held by a user, including property that is stored and/or maintained by a third-party entity. As used herein, a “resource” may refer to a computing component which may be held and operated by a user or operated and operated by a third-party entity.

Computing systems and their components, especially servers, applications, and networks, can be randomly inundated by interruption events which can be difficult to manage, prioritize, and expect. Such interruption events can happen in what some in the industry call, “event floods,” where a sudden occurrence of a huge volumes of alerts and interruptions are received or identified within a computing system or its network of components, and can lead to slower processing speeds, unintended outages, and/or the like. The problem is even more exacerbated when each interruption event is only handled based on the priority of when they are identified or received, rather than based on importance or criticality to the overall computing system and network. Thus, there exists a need for a system and/or method that can accurately, efficiently, and dynamically determine each interruption event's criticality, priority, and importance such that each interruption event is handled without the need for human intervention and without unnecessary delay or down-time.

The disclosure provided herein comprises systems and methods for prioritizing events (such as incident events and/or incident tickets) before the events enter the event management system for handling the events, and by assigning preferences for which events are critical or important. In order to complete this process, the disclosure comprises a stochastic diffusion search (SDS) algorithm which enables collective problem solving through computer agents which may analyze each of the events and update their belief statuses on the criticality and priority/preference for each event. Each agent may determine the criticality and priority/preference of each incoming event in parallel, rather than based on a first-come basis. Additionally, and once the belief statuses have been updated, the invention may input the updated belief statuses and the data regarding each event to a diagnostic inference model (DIM) which may use an aggregation of different modeling scenarios (e.g., rule-based reasoning, model-based reasoning, knowledge-based fuzzy logic, root cause chaining, and code-based reasoning) to determine which events are the most critical and high priority, which events are non-critical and low priority, and which events are false events and non-critical as no actions are needed. Once the criticality and priority has been accurately determined, the highest priority events may be fed to the event management system first.

Accordingly, the present disclosure provides for an identification of at least one interruption event; and application of the at least one interruption event to a stochastic diffusion search (SDS) engine; a determination, by the SDS engine, of a number of computing agents (e.g., computing bots which may act in parallel and together to determine the belief states for each interruption); and an analyzation of the at least one interruption event by the number of computing agents (e.g., where the number may change based on the current load on the system and its server(s)). Further, the present disclosure may provide for an update, by the number of computing agents, of at least one agent priority state for the at least one interruption event; an application of the at least one agent priority state to a diagnostic inference model (DIM); and a determination, by the DIM, of whether the at least one interruption event is a critical event, a non-critical event, or a false event (e.g., whereby the critical events may be input to an event management system first).

Indeed, and importantly, the disclosure provided herein creates prioritization logic which may be used for incoming interruption events (especially in event floods where a multitude of interruption events occur close in time or at the same time) to determine the correct prioritization and criticality of each interruption event for input to an event management system, which will then solve each interruption event as it comes in. The disclosure provided herein does this by using a stochastic diffusion search (SDS) engine or algorithm, which allows collective problem solving by using a population of computing agents which update their agent priority states (e.g., belief states) regarding the significance or priority of different interruption events. For example, in the context of software infrastructure event flood management, each computing agent represents a potential solution or action to mitigate the event flood and its individual interruption events. Thus, the collective nature of the SDS engine allows for distributed decision-making and problem solving, which in turn enables efficient handling of event floods and their interruption events by prioritizing the events and allowing for preferential processing of critical or important events before they enter the event management system.

What is more, the present invention provides a technical solution to a technical problem. As described herein, the technical problem includes the accurate and efficient determination and prioritization of interruption events in a computing system or network. The technical solution presented herein allows for the accurate, efficient, and dynamic determination and prioritization of the these interruption events for an event management system. In particular, the disclosure provided herein is an improvement over existing solutions to the determination and prioritization of these interruption events, (i) with fewer steps to achieve the solution, thus reducing the amount of computing resources, such as processing resources, storage resources, network resources, and/or the like, that are being used (e.g., such as by employing the right number of computing agents needed and allowable for the computing system and/or its server); (ii) providing a more accurate solution to problem, thus reducing the number of resources required to remedy any errors made due to a less accurate solution (e.g., without the need for human intervention and the associated computing resources necessary for human interaction); (iii) removing manual input and waste from the implementation of the solution, thus improving speed and efficiency of the process and conserving computing resources; (iv) determining an optimal amount of resources that need to be used to implement the solution, thus reducing network traffic and load on existing computing resources (e.g., determining the correct number of computing agents based on the AI plugin's determination of peak load time and low load time for a server). Furthermore, the technical solution described herein uses a rigorous, computerized process to perform specific tasks and/or activities that were not previously performed. In specific implementations, the technical solution bypasses a series of steps previously implemented, thus further conserving computing resources.

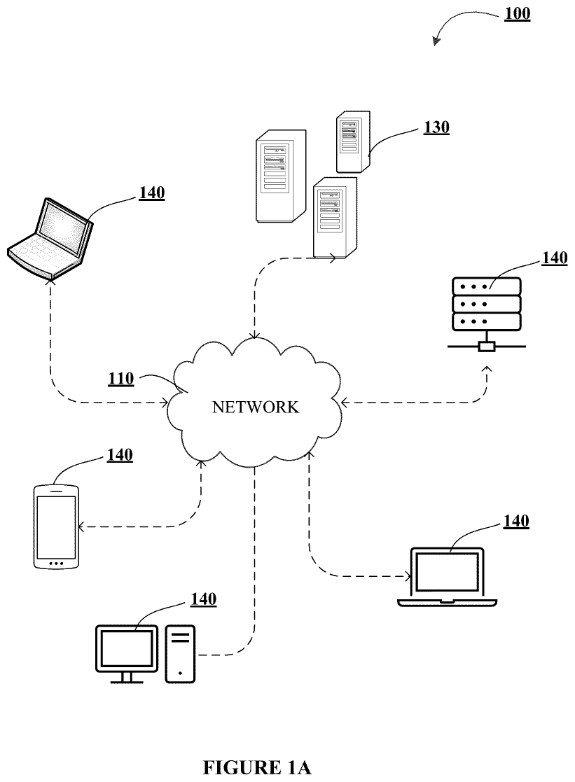

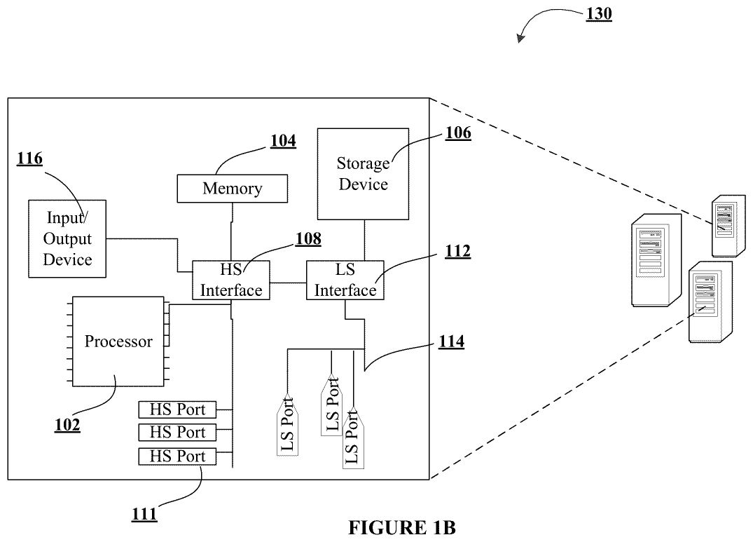

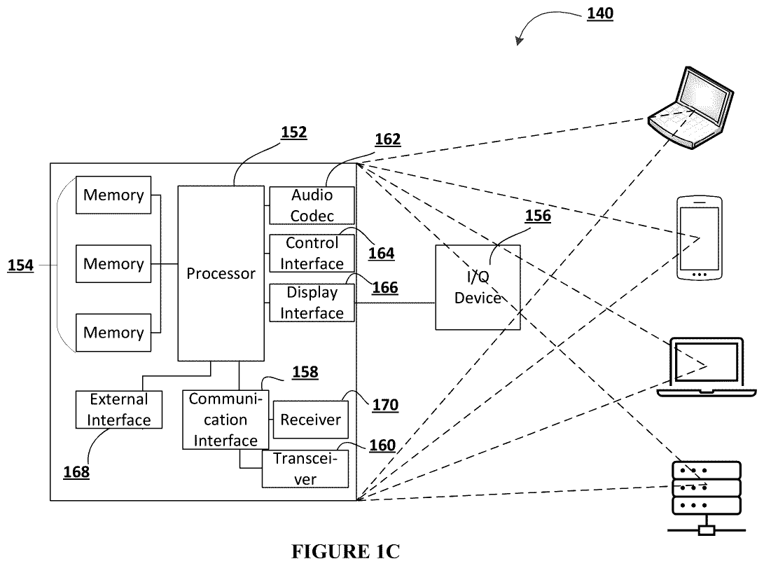

FIGS. 1A-1C illustrate technical components of an exemplary distributed computing environment for implementing AI to generate a time-sensitive notifications related to configuration of GUIs 100, in accordance with an embodiment of the invention. As shown in FIG. 1A, the distributed computing environment 100 contemplated herein may include a system 130 (i.e., the system as described herein), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

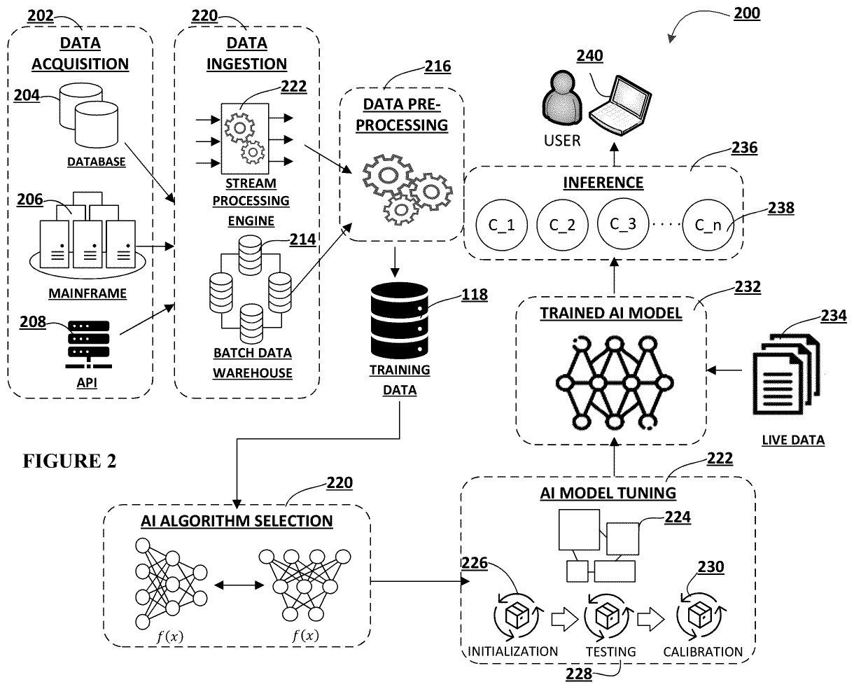

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence engine can learn from it. For example, labels might indicate whether a photo contains a bird or car, or which words were uttered in an audio recording. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

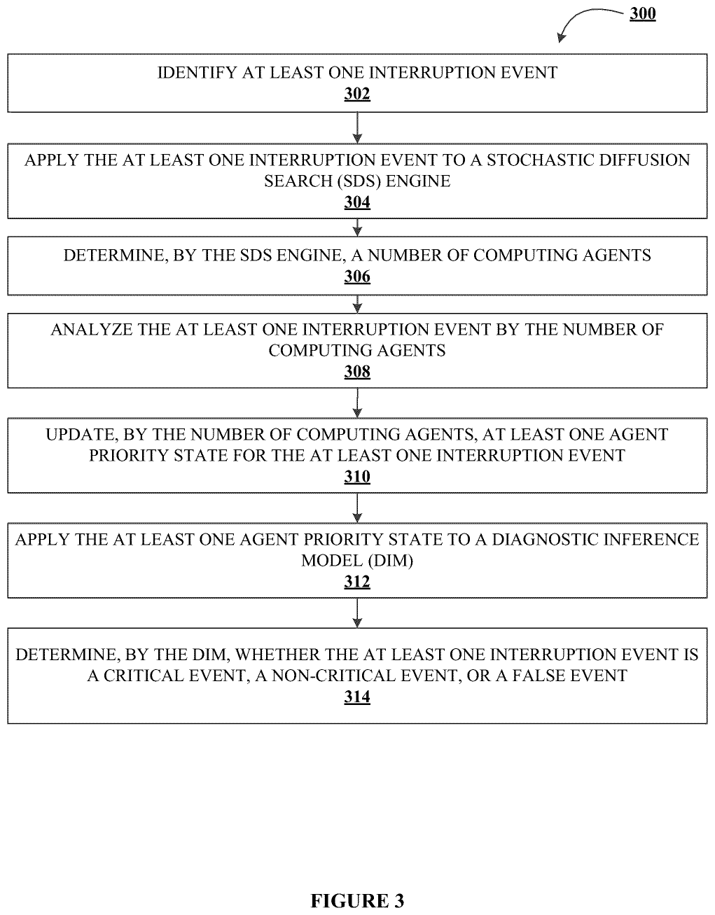

FIG. 3 illustrates a process flow 300 for determining and prioritizing interruption events to improve computer processing and performance in an electronic network, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of identifying at least one interruption event. For instance, the system may identify at least one interruption event based on receiving and/or identifying an incident ticket (e.g., which may indicate that an incident or interruption has occurred within a network, within a computing system, for an application, and/or the like), receiving and/or identifying a processing speed interruption or slow-down, a memory interruption (e.g., an interruption to computer memory capabilities), and/or the like. As used herein, the at least one interruption event may refer synonymously to an incident event, which comprises an unexpected (or in some instances, an expected) event that disrupts the normal operation of a computing system or network.

In some embodiments, the system may identify a plurality of interruptions, such as a flood of events or event flood. As used herein, the term “event flood” refers to multiple incident events identified in a computing system over a short period of time (e.g., over a short enough period that cannot be solved as the incidents come in and/or are identified).

In some embodiments, the system may keep track of every interruption event as it is identified and/or received, and may keep a running record or each of the interruption events, such as in a database, a record, an index, and/or the like. In some embodiments, and upon recording each interruption event, the system may continue with the process described below and herein, such that every interruption event is tracked and recorded based on a timestamp when it is identified and/or received.

As shown in block 304, the process flow 300 may include the step of applying the at least one interruption event to a stochastic diffusion search (SDS) engine. For example, the SDS engine as used herein refers to a stochastic diffusion search engine is an engine (which may comprise AI, machine learning, and/or the like) which employs various computing bots, algorithms, computing agents, and/or the like, which are designed to collaboratively (i.e., with the other computing bots/computing agents) explore a search space or problem space to find solutions to the at least one interruption event. For example, the SDS engine may employ a number of computing agents to explore a solution search space, such as a database or index of potential solutions to the interruption event, in order to determine an optimal or best solution to the interruption event. Further, each computing agent within the SDS engine will share each of their knowledge through probabilistic methods with other computing agents within the SDS engine through a diffusion process, which then allows each computing agent to collectively search the solution space effectively and efficiently. Specifically, the unique characteristics of the SDS engine and its ability to exhibit emergent behavior is important to this disclosure and process. Indeed, as the computing agents interact and exchange information, the collective behavior of the population emerges, leading to an intelligent problem-solving without the need for centralized control or manual intervention/control. Thus, in event flood management and individual interruption event management, this emergent behavior can enable the SDS engine to adapt and respond dynamically to changing event patterns and event flood patterns and to changing system conditions (e.g., such as those changing based on load times).

In some embodiments, such probabilistic methods may comprise iteratively searching the search space to find potential solutions to the interruption event(s), until all potential solutions have been found, whereby each iteration of the search space may change for each computing agent based on other solutions found by other computing agents that may have worked or not worked. In some embodiments, the iteration of searching the search space may be stopped based on a predetermined time (e.g., such as a time imposed by the system itself, by a manager of the system, by a client of the system, and/or the like). In some embodiments, the iterations of searching the search space may be based on a predetermined number of iterations for each computing agent (e.g., once a predetermined threshold for iterations of searching and testing solutions has been met by each computing agent, then each computing agent may continue the process described hereinbelow).

As shown in block 306, the process flow 300 may include the step of determining—by the SDS engine—a number of computing agents. Additionally, and as used herein, the number of computing agents within the SDS engine for each incident event may be determined and dynamically changed based on different factors. Such factors may comprise the overall computing system and its servers' peak load time or low load time (e.g., where a peak load time on a server is anticipated or occurring, less computing agents may be used by the SDS engine such that the overall computing system is not overloaded). In some embodiments, another factor may comprise the type of interruption event that is received and/or identified, such as a type of computing component that the interruption event effects (e.g., where an important computing component to the overall computing system may cause the SDS engine to employ more computing agents).

As used herein, the computing agents as described herein refers to computing bots which are trained and configured to automatically perform searches within the SDS engine and within the search space of the SDS engine.

As shown in block 308, the process flow 300 may include the step of analyzing the at least one interruption event by the number of computing agents. For example, the system may analyze the at least one interruption event (or plurality of interruption events in parallel) by the number of computing agents within the SDS engine. Such an analysis of the interruption event(s) may occur in parallel by each of the computing agents (e.g., such as where multiple computing agents are searching the search space with respect to a single interruption event, and/or where multiple computing agents are searching the search space with respect to multiple interruption events, and/or the like).

In some embodiments, the data in the diffusion process comprises event type data, timestamp data, and/or associated metadata of the at least one interruption event. For example, the diffusion process of the SDS engine may use current data of the current interruption event(s), such as but not limited to event type data (e.g., interruption event data such as the computing component(s) affected by the interruption event, the type of computing component(s) affected, and/or the like); timestamp data (e.g., the timestamp of when the interruption event was received, identified, and/or occurred); and/or associated metadata (e.g., any account identifiers where the interruption event may have occurred, an identifier of a condition that may have triggered the interruption event, and/or the like).

In some embodiments, the diffusion process of the SDS engine may use previous or historical interruption event data, such as but not limited to historical event type data (e.g., interruption event data of past or historical interruption events, such as but not limited to the type of interruption event, the affected computing component(s) of the historical interruption event(s), and/or the like), timestamp data (e.g., timestamps of past/historical interruption event(s), timestamp(s) when the historical interruption event was closed or solved, and/or the like), and/or associated metadata (e.g., data of historical solutions that were used on the historical interruption event(s), historical account identifiers, historical condition identifiers, and/or the like). As used herein, the computing agents may share the data of the diffusion process between other computing agents (e.g., current data and/or historical data like that described above).

As shown in block 310, the process flow 300 may include the step of updating—by the number of computing agents—at least one agent priority state for the at least one interruption event. For example, the system may update or determine the number of computing agents that should be used within the SDS engine for the interruption event(s), whereby based on the analysis of the computing agent(s) (e.g., based on the search space and solutions searched), the computing agent(s) may update their belief state (i.e., agent priority state) of how to prioritize the interruption event(s).

Such a belief state or agent priority state may indicate a priority of the interruption event(s) analyzed by the computing agents, where the priority will be used to determine when the interruption event(s) should be input to an event management system for solving. In some embodiments, the agent priority state may comprise a weight and/or a confidence score, which may be used to rate the agent priority state among other agent priority states for other interruption events. Thus, and by way of example, the weight and/or confidence score may be considered a higher priority based on the higher weight and/or confidence score by the computing agents for a given interruption event as compared to the weight and/or confidence scores of other interruption events. In some embodiments, agent priority state from each computing agent analyzing the interruption event may be aggregated to generate an overall weight and/or confidence score for the agent priority state of the interruption event. In some other embodiments, the agent priority state from each computing agent may be averaged all together to generate the overall weight and/or confidence score for the agent priority state of the interruption event.

Additionally, and in some embodiments, all of the interruption events that have been analyzed by the computing agents and have not yet been solved or input to the event management system may be compared based on their weight and/or confidence score, whereby their individual weights and/or confidence scores may be used to rank the interruption events for their prioritization. For example, and where the weight and/or confidence score of an interruption event is highest compared to other weights and/or confidence scores of other interruption events, the priority of the first interruption event may be ranked as a higher priority compared to other interruption events.

In some embodiments, the at least one of the weight or the confidence score may be compared to at least one belief state threshold, and based on the comparison, the at least one agent priority state is determined. For example, and in some embodiments, weight and/or confidence score may be compared against at least one belief state threshold to determine the agent priority state for interruption event (e.g., the overall weight and/or confidence score compared to the at least one belief state threshold, and/or each weight and/or confidence score compared to the at least one belief state threshold which may then be averaged) based on the weight and/or confidence score meeting and/or surpassing the at least one belief state threshold. In some embodiments, there may be various levels of belief state thresholds (e.g., various belief state thresholds, whereby each represents a level of an agent priority state/priority of the interruption event). Thus, and by way of example, a lowest belief state threshold may be used to indicate an interruption event with a lowered priority (e.g., when the weight and/or confidence score only surpasses the lowest level), a mid-level belief state threshold may be used to indicate an interruption event with a middle priority, and a highest belief state threshold may be used to indicate an interruption event with a highest priority.

As shown in block 312, the process flow 300 may include the step of applying the at least one agent priority state to a diagnostic inference model (DIM). For instance, the DIM may be a trained model which is configured to use at least one method to determine whether the interruption event is a critical event, a non-critical event, a false positive event, and/or the like. For example, the DIM may comprise a plurality of methods and/or models, whereby each of the outputs for each of the methods and/or models may be aggregated together to generate a result aggregation which may then be used to determine whether the interruption event is a critical event, non-critical event, a false event, and/or the like. In some embodiments, the methods and/or models may comprise a case-based reasoning method, a model-based reasoning method, a rule-based reasoning method, a knowledge-based fuzzy logic method, a root-cause chaining method, and/or the like. Such a DIM, using these various methods and/or models may further prioritize and filter the interruption events to determine the most critical from false positive events, and/or the like.

For example, and in some embodiments, the case-based reasoning method may comprise using historical data of past interruption events, which may be stored in a database such as a metrics database. Such historical interruption event data may then be used by the case-based reasoning method to determine which kinds of interruption events should be considered the most critical, which may be considered non-critical, and which may be considered false positive (e.g., not critical at all and not an interruption event at all, even if they first appear to be). In some embodiments, the case-based reasoning method may compare the data of the current interruption event(s) against data of historical interruption events in order to sort the current interruption events into particular categories. For example, and in some embodiments, the case-based reasoning may use data stored in a database (e.g., a metrics database) which comprise past or historical interruption events and compare the current interruption event data with similar historical interruption events from a knowledge base (e.g., within the metrics database) and uses this data to identify the most appropriate category (e.g., critical event category, non-critical event category, false positive event category, and/or the like) for the current interruption event.

In some embodiments, the resolution time for the historical interruption events may be considered by the case-based reasoning method in order to determine the most critical, non-critical, and false positive events (e.g., where the greater the resolution time, the more critical the interruption event).

Additionally, and in some embodiments, the model-based reasoning method may comprise constructing and configuring a model that represents a computing system's behavior(s) and categorizing interruption events based on identifying known relationships and dependencies between interruption event data and their features and the known categories. In some embodiments, the model may be pre-trained based on historical interruption event data and the relationships between the features of the historical interruption events and their categorizations.

In some embodiments, the rule-based reasoning method may comprise pre-defined rules and/or conditions to categorize the interruption events, whereby the pre-defined rules are derived from manual inputs and/or heuristics. For example, and in some embodiments, the rule-based reasoning method may comprise pre-defined rules between interruption events, pre-defined rules between features, and their corresponding categories. In some such embodiments, the pre-defined rules are applied either sequentially based on each individual interruption event's features and data, and/or in parallel (all at once) to determine the correct category.

In some embodiments, the knowledge-based fuzzy logic method may comprise logic principals to handle indecision and uncertainty in interruption event categorization by capturing the gradual transition between event categories and their associated features and data (e.g., data of the interruption events between categories). In some embodiments, the knowledge-based fuzzy logic may handle the instance where interruption events exhibit characteristics of multiple categories and determine the most appropriate category from the multiple categories by filtering out the characteristics that do not lead to the most appropriate category.

In some embodiments, the root-cause chaining (cause chaining) model may comprise an identification of a causal relationship among interruption events, where the root-cause chaining model uses relationships between interruption events and their implications/effects to find the appropriate category. For example, and in some embodiments, the root-cause chaining model may identify a chain of events that lead to the effects of the interruption events and categorizes accordingly.

Thus, the DIM, as used herein, determines how the incident events are prioritized based on their criticality and importance. In some embodiments, the priorities and criticality may be based on a threshold value, such as where the categories are each associated with a numerical threshold and each of the categories determined by the methods and models comprises a numerical valuation and are aggregated together to compare against the threshold of the DIM.

As shown in block 314, the process flow 300 may include the step of determining—by the DIM—whether the at least one interruption event is a critical event, a non-critical event, or a false event. As described hereinabove, the DIM may be used to determine what category the interruption event(s) fall into (e.g., a critical event, a non-critical event, a false positive event, and/or the like). Thus, and in some instances, the interruption event may be categorized as a critical event when the interruption event should be solved first among all the other interruption events. The non-critical event category and its associated interruption events refers to those interruption events that should be solved and handled after all the critical event interruption events have been solved. Lastly, the false positive events refer to those identified interruption events that will not need to be solved as they are not actual interruption events.

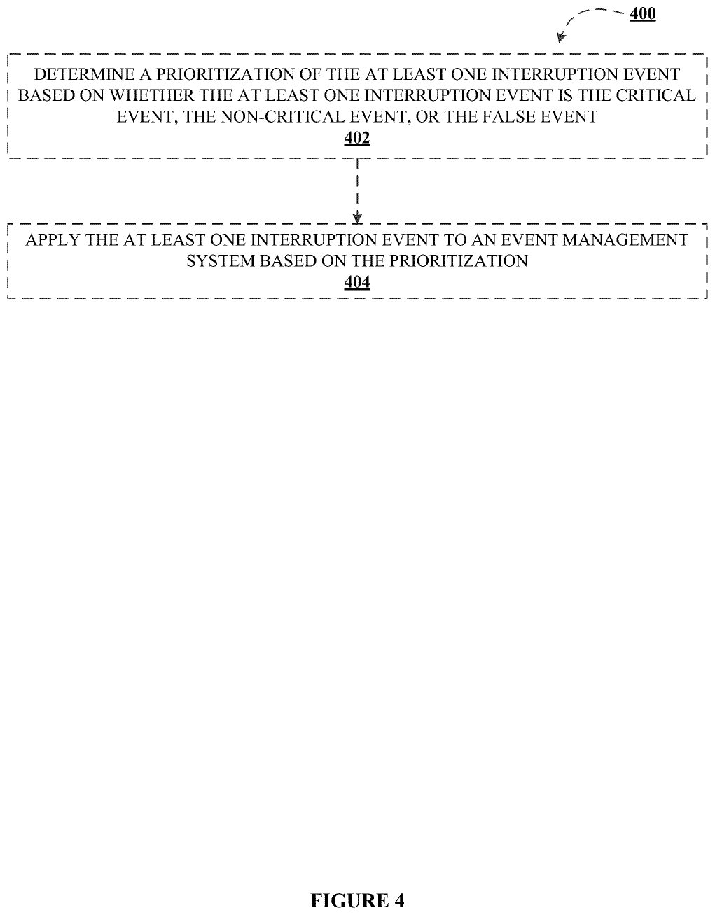

FIG. 4 illustrates a process flow 400 for applying the at least one interruption event to an event management system based on the prioritization, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400.

In some embodiments, and as shown in block 402, the process flow 400 may include the step of determining a prioritization of the at least one interruption event based on whether the at least one interruption event is the critical event, the non-critical event, or the false event. For example, the system may rank the interruption events that are input to an event management system, such that each of the critical event interruption events are input first to an event management system and the non-critical event interruption events are input last to the event management system. In some embodiments, only those interruption events that are part of an event flood are handled in a sequence, whereby an event flood with multiple interruption events are input to the event management system sequentially and based on their categorizations before a new event flood is input to the event management system. In this manner, the event management system will not be inundated by only those critical events such that a backlog of non-critical events is not created.

In some embodiments, and as shown in block 404, the process flow 400 may include the step of applying the at least one interruption event to an event management system based on the prioritization. Thus, and as described herein, the system will input the those interruption events that have been categorized as critical events first (indicating a higher priority) and the interruption events that have been categorized as non-critical events second or last (indicating a lower priority).

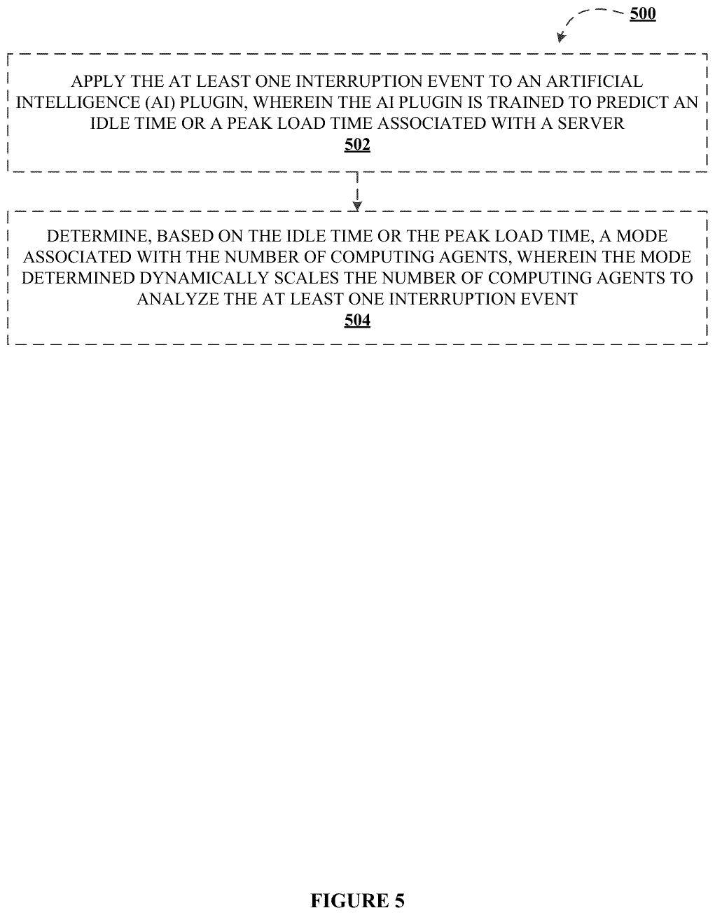

FIG. 5 illustrates a process flow 500 for determining a mode associated with the number of computing agents, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500.

In some embodiments, and as shown in block 502, the process flow 500 may include the step of applying the at least one interruption event to an artificial intelligence (AI) plugin, wherein the AI plugin is trained to predict an idle time or a peak load time associated with a server. For example, and in some embodiments, the server may be associated with the system described herein, whereby the server is concerned with carrying out the procedures described herein for prioritizing interruption events. Thus, such a server may go through different peak load times, slow or idle times, and/or normal load times (e.g., when the server has a normal or average load to process) when handling different procedures or processes. For example, and in some embodiments, the server may be a peak load time, which may indicate that the server is operating with the heaviest demand (such as what would be generated at peak user times). In some embodiments, the server may operate a low or idle time when the server is not delivering information or processing services due to a lack of requests on the server.

Additionally, and in some embodiments, the system may track and record each of the peak load times, idle load times, normal load times, and/or the like. For example, and in some embodiments, the record of load times may be stored in the metrics database, like that already described hereinabove. Further, and based on this record, the system may train an AI plugin (e.g., similar to the AI engine shown and described above with respect to FIG. 2) to predict these load times at a future time. Additionally, and in some embodiments, the AI plugin may be pretrained based on the metrics database comprising historical data of the server, and further comprising optimal performance time and optimal response time. For instance, the metrics database may comprise data regarding optimal performance time and optimal response time for the server based on the load times and the SDS computing agents that were used, such that during these load times, the number of computing agents chosen, and which resulted in optimal performance time and optimal response time may be used again at a future time. Thus, and in some embodiments, the AI plugin may be trained on historical data regarding the interruption events, the server load times, response times, frequency of interruption events, severity of events, CPU utilization, response incidents, and/or the like.

In some embodiments, and as shown in block 504, the process flow 500 may include the step of determining—based on the idle time or the peak load time—a mode associated with the number of computing agents, wherein the mode determined dynamically scales the number of computing agents to analyze the at least one interruption event. For example, and in some embodiments, the system may—through the AI plugin's prediction of load time on the server at the current interruption event(s)—determine the appropriate number of computing agents to analyze the interruption event(s) without overloading the server or overall computing system.

For example, and in some embodiment, the mode determined by the AI plugin may comprise at least one of an idle mode, a self-healing mode, a normal mode, or a high performance mode, which in turn will be used to determine the number of computing agents that should be used. Such a mode may be used to identify the current mode of the server (e.g., idle mode indicating a low peak time, a self-healing mode for updating and solving the interruption event without human intervention and requiring minimal resources, a normal mode to indicate a normal load time, and a high performance mode to indicate a peak load time). Thus, and based on the level of load time, the computing agents may be added or removed based on the mode of the server.

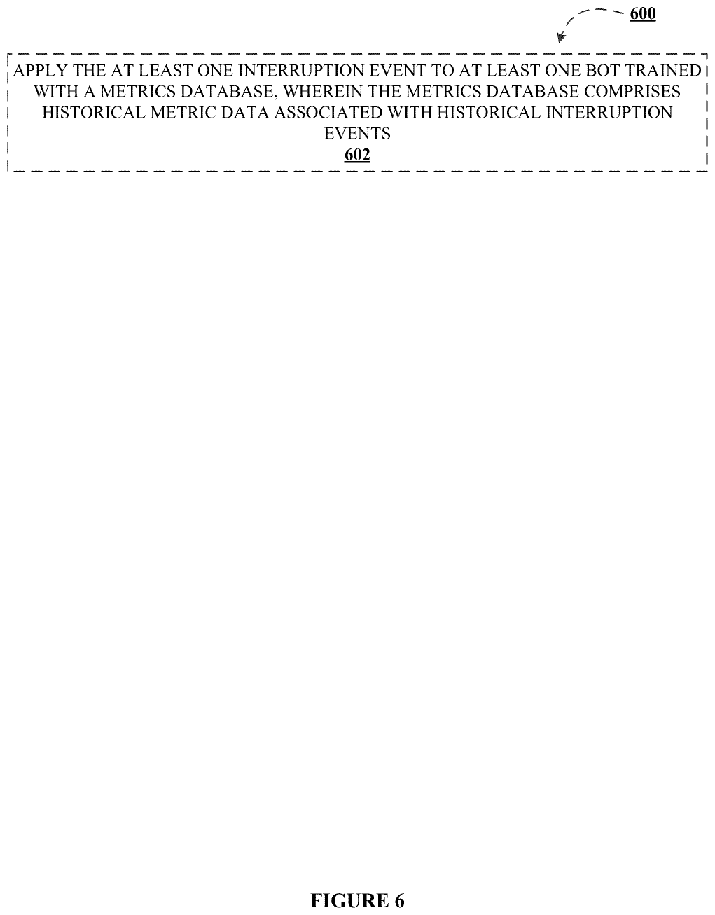

FIG. 6 illustrates a process flow 600 for applying the at least one interruption event to at least one bot trained with a metrics database, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600.

In some embodiments, and as shown in block 602, the process flow 600 may include the step of applying the at least one interruption event to at least one bot (or at least one computing agent) trained with a metrics database, wherein the metrics database comprises historical metric data associated with historical interruption events. For example, and as briefly described above with respect to FIG. 5, the number of computing agents may be dynamically and automatically determined based on the historical data of the computing system (e.g., and its server(s), load times, and/or the like), whereby such data may be stored in a metrics database as historical data, and may be used with the computing agent as an input to the SDS engine. In some embodiments, such computing agents and/or bots may be used to filter the data being input to the SDS engine, such that only the data necessary (e.g., non-noisy data, non-redundant data, and/or the like) is filtered out before being input to the SDS engine.

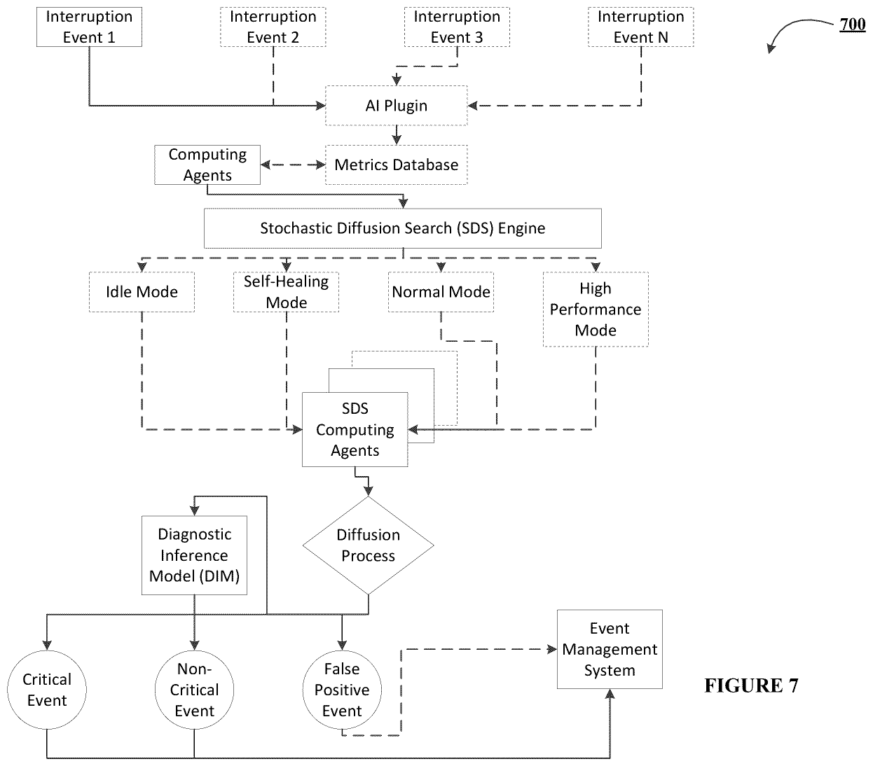

FIG. 7 illustrates an exemplary flow diagram for determining and prioritizing interruption events to improve computer processing and performance in an electronic network, in accordance with an embodiment of the disclosure. In some embodiments, a system (e.g., similar to one or more of the systems described herein with respect to FIGS. 1A-1C) may perform one or more of the steps of flow 700. For example, a system (e.g., the system 130 described herein with respect to FIG. 1A-1C) may perform the steps of flow 700. In some embodiments, an artificial intelligence engine (e.g., such as the AI engine shown in FIG. 2) may perform some or all of the steps described in flow 700.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. The system for determining and prioritizing interruption events to improve computer processing and performance in an electronic network, the system comprising:
a memory device with computer-readable program code stored thereon;
at least one processing device operatively coupled to the at least one memory device and the at least one communication device, wherein executing the computer-readable code is configured to cause the at least one processing device to:
identify at least one interruption event;
apply the at least one interruption event to a stochastic diffusion search (SDS) engine;
determine, by the SDS engine, a number of computing agents;
analyze the at least one interruption event by the number of computing agents;
update, by the number of computing agents, at least one agent priority state for the at least one interruption event;
apply the at least one agent priority state to a diagnostic inference model (DIM); and
determine, by the DIM, whether the at least one interruption event is a critical event, a non-critical event, or a false event.

2. The system of claim 1, wherein executing the computer-readable code is configured to cause the at least one processing device to:
determine a prioritization of the at least one interruption event based on whether the at least one interruption event is the critical event, the non-critical event, or the false event; and
apply the at least one interruption event to an event management system based on the prioritization.

3. The system of claim 1, wherein executing the computer-readable code is configured to cause the at least one processing device to:
apply the at least one interruption event to an artificial intelligence (AI) plugin, wherein the AI plugin is trained to predict an idle time or a peak load time associated with a server; and
determine, based on the idle time or the peak load time, a mode associated with the number of computing agents, wherein the mode determined dynamically scales the number of computing agents to analyze the at least one interruption event.

4. The system of claim 3, wherein the AI plugin is pretrained based on a metrics database comprising historical data of the server, further comprising optimal performance time and optimal response time.

5. The system of claim 3, wherein the mode comprises at least one of an idle mode, a self-healing mode, a normal mode, or a high performance mode.

6. The system of claim 1, wherein executing the computer-readable code is configured to cause the at least one processing device to:
apply the at least one interruption event to at least one bot trained with a metrics database, wherein the metrics database comprises historical metric data associated with historical interruption events.

7. The system of claim 1, wherein the at least one agent priority state is associated with at least one of a weight or a confidence score.

8. The system of claim 7, wherein the at least one of the weight or the confidence score is compared to at least one belief state threshold, and based on the comparison, the at least one agent priority state is determined.

9. The system of claim 1, wherein the number of computing agents exchange data in a diffusion process, and wherein the diffusion process further comprises a probabilistic exchange between the number of computing agents.

10. The system of claim 9, wherein the data in the diffusion process comprises event type data, timestamp data, or associated metadata of the at least one interruption event.

11. A computer program product for determining and prioritizing interruption events to improve computer processing and performance in an electronic network, wherein the computer program product comprises at least one non-transitory computer-readable medium having computer-readable program code portions embodied therein, the computer-readable program code portions which when executed by a processing device are configured to cause the processor to perform the following operations:
identify at least one interruption event;
apply the at least one interruption event to a stochastic diffusion search (SDS) engine;
determine, by the SDS engine, a number of computing agents;
analyze the at least one interruption event by the number of computing agents;
update, by the number of computing agents, at least one agent priority state for the at least one interruption event;
apply the at least one agent priority state to a diagnostic inference model (DIM); and
determine, by the DIM, whether the at least one interruption event is a critical event, a non-critical event, or a false event.

12. The computer program product of claim 11, wherein the processing device is further configured to cause the processor to perform the following operations:
determine a prioritization of the at least one interruption event based on whether the at least one interruption event is the critical event, the non-critical event, or the false event; and
apply the at least one interruption event to an event management system based on the prioritization.

13. The computer program product of claim 11, wherein the processing device is further configured to cause the processor to perform the following operations:
apply the at least one interruption event to an artificial intelligence (AI) plugin, wherein the AI plugin is trained to predict an idle time or a peak load time associated with a server; and
determine, based on the idle time or the peak load time, a mode associated with the number of computing agents, wherein the mode determined dynamically scales the number of computing agents to analyze the at least one interruption event.

14. The computer program product of claim 13, wherein the AI plugin is pretrained based on a metrics database comprising historical data of the server, further comprising optimal performance time and optimal response time.

15. The computer program product of claim 11, wherein the number of computing agents exchange data in a diffusion process, and wherein the diffusion process further comprises a probabilistic exchange between the number of computing agents.

16. A computer implemented method for determining and prioritizing interruption events to improve computer processing and performance in an electronic network, the computer implemented method comprising:
identifying at least one interruption event;
applying the at least one interruption event to a stochastic diffusion search (SDS) engine;
determining, by the SDS engine, a number of computing agents;
analyzing the at least one interruption event by the number of computing agents;
updating, by the number of computing agents, at least one agent priority state for the at least one interruption event;
applying the at least one agent priority state to a diagnostic inference model (DIM); and
determining, by the DIM, whether the at least one interruption event is a critical event, a non-critical event, or a false event.

17. The computer implemented method of claim 16, further comprising:
determining a prioritization of the at least one interruption event based on whether the at least one interruption event is the critical event, the non-critical event, or the false event; and
applying the at least one interruption event to an event management system based on the prioritization.

18. The computer implemented method of claim 16, further comprising:
applying the at least one interruption event to an artificial intelligence (AI) plugin, wherein the AI plugin is trained to predict an idle time or a peak load time associated with a server; and
determining, based on the idle time or the peak load time, a mode associated with the number of computing agents, wherein the mode determined dynamically scales the number of computing agents to analyze the at least one interruption event.

19. The computer implemented method of claim 18, wherein the AI plugin is pretrained based on a metrics database comprising historical data of the server, further comprising optimal performance time and optimal response time.

20. The computer implemented method of claim 16, wherein the number of computing agents exchange data in a diffusion process, and wherein the diffusion process further comprises a probabilistic exchange between the number of computing agents.
